(19) United States
(12) Patent Application Publication
(10) Pub. No.: US 2005/0108301 A1
(43) Pub. Date: May 19, 2005

(54) Method for balancing wear when writing data in a flash memory

(76) Inventors: Changjian Lou, Shenzhen (CN); Tang He, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/841,578

(22) Filed: May 6, 2004

(30) Foreign Application Priority Data
Nov. 14, 2003 (TW) 92131967

(51) Int. Cl. G06F 12/00

(52) U.S. Cl. 707/203

(57) ABSTRACT

A method for writing data to a flash memory which balances wear of the flash memory includes the steps of: searching for void file nodes in the flash memory based on availability identifiers of the file nodes; sequencing the void file nodes based on node versions thereof; writing the data to one or more of the void file nodes in ascending order of node versions of the file nodes; building node link information of the file nodes that have been written; updating a node version of the at least one file node that has been written; and marking the file nodes that have been written with an unavailable flag. A method for modifying file contents of a flash file stored in a flash memory which balances wear of the flash memory is also provided.

### BACKGROUND OF THE INVENTION

1. Field of the Invention

The present invention relates to a method for writing data to a flash memory, and particularly to a method for writing data to a flash memory which balances wear of the flash memory. This application relates to a contemporarily filed application having the same inventors, the same title and the same assignee with the instant invention.

2. Background of the Invention

Currently, personal portable electronic products generally employ two means to store data: one is a random access memory (RAM), and the other is a flash memory. The RAM is relatively cheap, and has fast access rates. However, the RAM must work with a power supply in order to store data. If the power supply is shut off, data stored in the RAM is lost. At present, there are no personal portable electronic products that can provide a 24-hour power supply. Thus the RAM is not suitable for storing important data.

The flash memory is a kind of non-volatile memory (NVM). It has highly integrated components, and can protect data under conditions of no power supply. However, if the flash memory is performing an operation (such as writing or deleting) on data stored on a sector thereof while the power supply is shut off, data originally stored on the sector is prone to be lost. In addition, if the flash memory employs a File Allocation Table (FAT) file system, and the flash memory is simply updating a file allocation table or a ROOT table thereof when the power supply is shut off, all data on the flash memory is lost.

China Patent Application No. 01119887.7 published on Jan. 29, 2003 discloses a flash file management method. The invention treats each physical sector of a flash memory as a management unit that has a file head control information area, a data area, and a file status information area. Each file is made up of one or more management units. When a file is stored or modified, data on the file is stored in a void management unit. Then original management units concerned with the file are deleted, and the file allocation table in a RAM is modified accordingly.

The above-mentioned invention provides a stable flash file management method, and can minimize the risk of data loss when the power supply of the flash memory is shut off. However, the invention does not balance wear among the management units. That is, some of the physical sectors of the flash memory are used more frequently than others. The more frequently used physical sectors are prone to sustain the most wear and reach the end of their working lifetimes prematurely. This eventually leads to reduce capacity of the flash memory. Therefore, a method for balancing wear among the management units is needed to improve the useful working lifetime of the flash memory.

### SUMMARY OF THE INVENTION

Accordingly, an object of the present invention is to provide a method for writing data to a flash memory which balances wear of the flash memory.

Another object of the present invention is to provide a method for modifying file contents of a flash file stored in a flash memory which balances wear of the flash memory.

In order to accomplish the first above-mentioned object, a preferred method of the present invention for writing fresh data to a flash memory comprises the steps of: (i) searching for void file nodes in the flash memory based on availability identifiers of the file nodes; (ii) sequencing the void file nodes based on node versions thereof; (iii) writing the data to at least one of the void file nodes in ascending order of node versions of the file nodes; (iv) building node link information of the at least one file node that has been written; (v) updating a node version of the at least one file node that has been written; and (vi) marking the file nodes that have been written with an unavailable flag.

In order to accomplish the second above-mentioned object, a method of the present invention for modifying file contents of a flash file stored in a flash memory comprises the steps of: (i) finding first file nodes recording the file contents to be modified; (ii) searching for void file nodes in the flash memory, and selecting void file nodes as second file nodes; (iii) sequencing the second file nodes based on node versions thereof; (iv) writing modified contents of the first file nodes to certain of the second file nodes in ascending order of node versions of the second file nodes; (v) building node link information of each second file nodes that has been written; (vi) marking the first file nodes with a predetermined flag; and (vii) updating a node version of each second file node that has been written and vacating the first file nodes that have been marked with the predetermined flag.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of file nodes employed in the preferred embodiment of the present invention, each file node comprising a node head information area, a data area and a node status information area;

FIG. 2 is a schematic diagram of information of the node head information area of a file node of FIG. 1;

FIG. 3 is a schematic diagram of information of the node status information area of a file node of FIG. 1;

FIG. 4 is a flow chart of the preferred method for writing fresh data to a flash memory in accordance with the present invention; and

FIG. 5 is a flow chart of the preferred method for modifying file contents of a flash file stored in a flash memory in accordance with the present invention.

### DETAILED DESCRIPTION OF PREFERRED EMBODIMENTS OF THE INVENTION

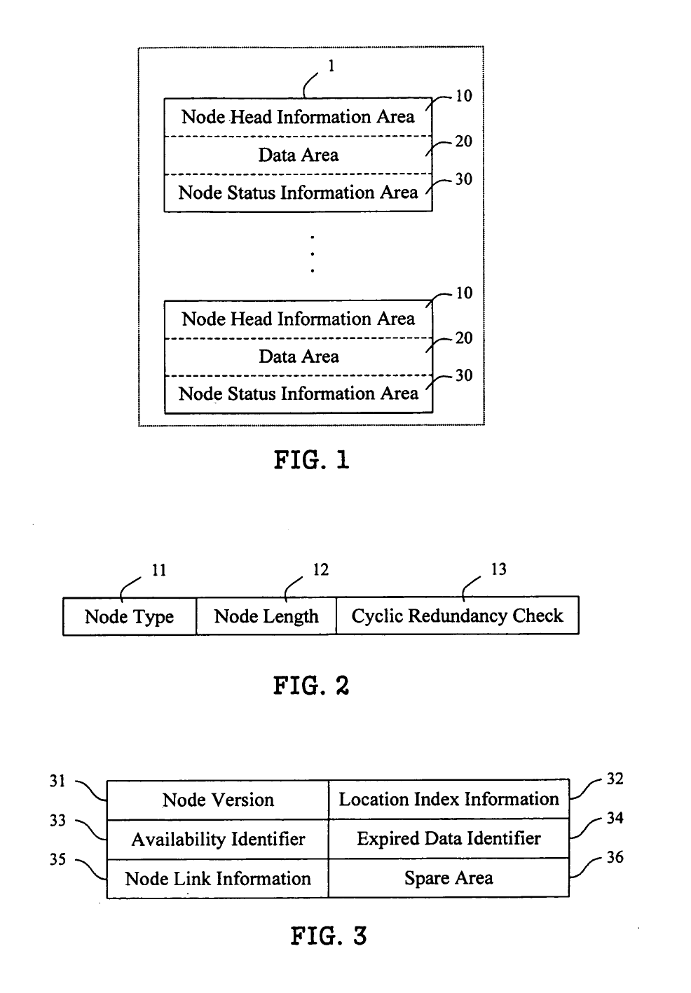

FIGS. 1-3 are schematic diagrams of file nodes 1 of a flash file in accordance with a preferred embodiment of the present invention. In the preferred embodiment, each flash file is made up of a series of file nodes 1. Each file node 1 comprises a node head information area 10, a data area 20, and a node status information area 30. The node head information area 10 is provided for storing information on a node head. The information on a node head comprises a node type 11, a node length 12, and a cyclic redundancy check (CRC) 13. The data area 20 is used for storing file contents. The node status information area 30 is configured for storing information on node status. The information on node status comprises a node version 31, location index information 32, an availability identifier 33, an expired data identifier 34, node link information 35, and a spare area 36. In the preferred embodiment, the node version 31 of a file node 1 indicates a time that the file node 1 was last written or vacated (see below).

When an operation, such as deleting or writing, is performed on the file node 1, a value of the node version 31 of the file node 1 is updated. For example, the value of the node version 31 is increased by 1. Therefore, if the file node 1 is used often, the value of the node version 31 thereof is correspondingly high. In the preferred embodiment, the file node 1 having the lowest node version 31 is written first. The location index information 32 of the file node 1 indicates a logic location of the file node in a flash memory. The availability identifier 33 of the file node 1 is provided for indicating whether the file node 1 is available. If the file node 1 is unavailable, the availability identifier 33 thereof is marked with an unavailable flag. The file node 1 may be unavailable because it has been written, or because it has been physically destroyed. In the preferred embodiment, if the file node 1 has been written or destroyed, the availability identifier 33 is marked with the character “U.” Conversely, if the file node 1 is available, the availability identifier 33 thereof is marked with an available flag, which in the preferred embodiment is the character “A.” In the preferred embodiment, when the file node 1 is available, this means that the file node 1 is void.

When data in the file node 1 are conveyed to another file node 1, the expired data identifier 34 of the file node 1 is marked with a predetermined flag such as the character “C.” File nodes 1 with the predetermined flag in the expired data identifier 34 are vacated after a fixed time period, or upon the next powering on of the flash file. The node link information 35 of each file node 1 is provided for recording information on a preceding file node 1 and an offspring file node 1 of that file node 1. Based on the node link information 35, file nodes 1 that make up a flash file can be linked up in a logic sequence. If a file node 1 is vacated, the node link information 35 thereof is canceled accordingly. The spare area 36 of the file node 1 is used for storing newly-added or temporarily-stored information on the file node 1.

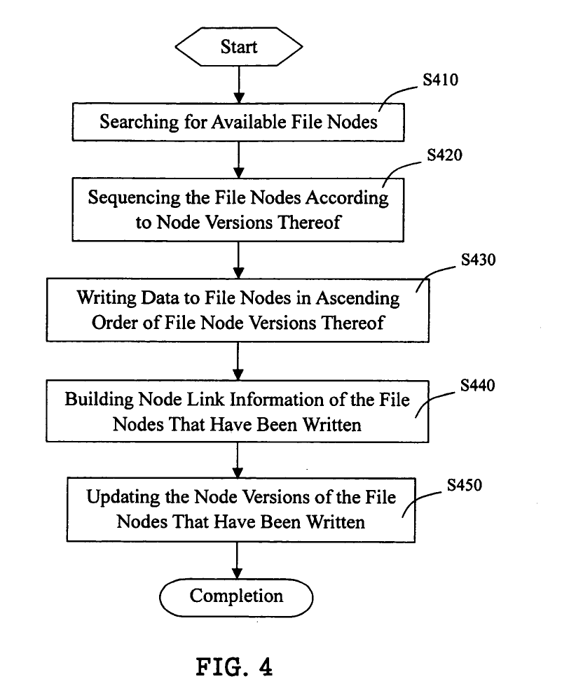

FIG. 4 is a flow chart of the preferred method for writing fresh data to a flash memory which balances wear of the flash memory. At step S410, the flash memory searches for available file nodes having lowest node versions 31 thereof. At step S420, the flash memory sequences the available file nodes 1 based on node versions 31 thereof. At step S430, the flash memory writes the fresh data to one or more of the available file nodes. The file node 1 with the lowest node version 31 is written first, and subsequent file nodes 1 are written in ascending order of file node version 31 thereof. At step S440, the flash memory builds node link information of the file nodes 1 that have been written. The node link information is information on a logic sequence of the file nodes 1 from a preceding file node 1 to an offspring file node 1. At step S450, the flash memory updates the node versions 31 of the file nodes 1 that have been written. That is, the values of the node versions 31 of the file nodes 1 that have been written are respectively increased by 1.

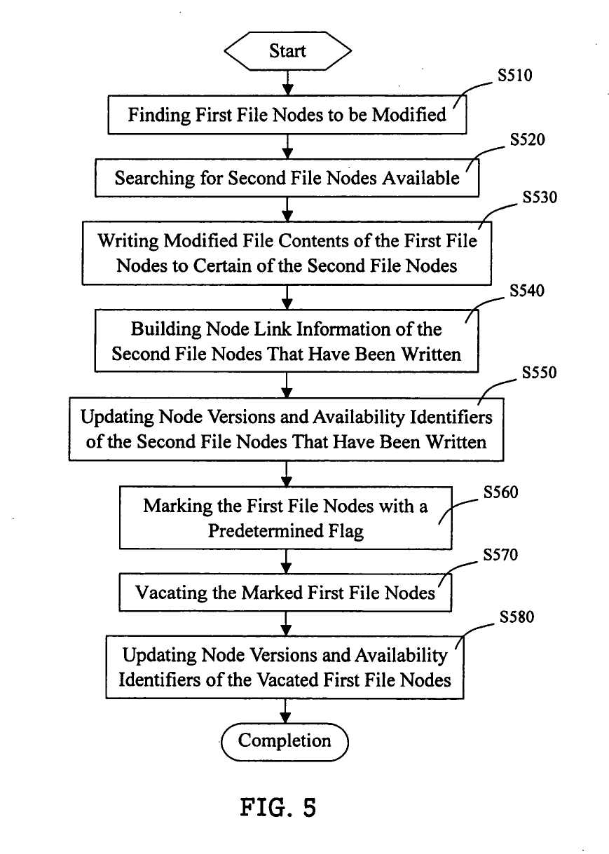

FIG. 5 is a flow chart of the preferred method for modifying file contents of a flash file stored in a flash memory which balances wear of the flash memory. At step S510, the flash memory finds first file nodes 1 which record the file contents that need to be modified, based on the location index information 32 of the file nodes 1 recording the file contents. At step S520, the flash memory searches for second file nodes 1 that are available, and sequences the second file nodes 1 in ascending order based on the node versions 31 thereof. At step S530, the flash memory writes modified file contents of the first file nodes 1 to one or more of the second file nodes 1. The second file nodes 1 with the lowest node version 31 are written first, and subsequent second file nodes 1 are written in ascending order of node versions 31 thereof. At step S540, the flash memory builds the node link information 35 of the second file nodes 1 that have been written. At step S550, the flash memory updates node versions 31 and availability identifiers 33 of the second file nodes 1 that have been written. In the preferred embodiment of the present invention, the values of the node versions 31 are respectively increased by 1. At step S560, the flash memory marks the expired data identifiers 34 of the first file nodes 1 with a predetermined flag. At step S570, after a fixed time period or upon the next powering on of the flash file, the first file nodes 1 with expired data identifiers 34 that are marked with the predetermined flag are vacated. At the same time, the link information thereof is canceled. Such first file nodes 1 thus become new available file nodes 1 without link information. At step S580, the flash memory updates the node versions 31 of the first file nodes 1 that have been vacated. In the preferred embodiment of the present invention, the values of the node versions 31 are respectively increased by 1. The flash memory also marks each of the first file nodes 1 that have been vacated with an available flag.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

1. A method for writing data to a flash memory which balances wear of the flash memory, the method comprising the steps of:
searching for void file nodes in the flash memory based on availability identifiers of the file nodes;
sequencing the void file nodes based on node versions thereof;
writing the data to at least one of the void file nodes in ascending order of node versions of the void file nodes;
building node link information of the at least one file node that has been written;
updating a node version of the at least one file node that has been written.

2. The method as recited in claim 1, further comprising the following step:
marking each file node that has been written with an unavailable flag.

3. The method as recited in claim 1, wherein the node version of a file node indicates a time that the file node was last written or vacated.

4. The method as recited in claim 1, wherein updating the node version comprises adding a fixed number to a value of the node version.

5. The method as recited in claim 1, wherein the node link information of the file node is information on a logic sequence of the file node from a preceding file node to an offspring file node.

6. A method for modifying file contents of a flash file stored in a flash memory which balances wear of the flash memory, the method comprising the steps of:
finding first file nodes recording the file contents to be modified;
searching for void file nodes in the flash memory, and selecting void file nodes as second file nodes;
sequencing the second file nodes based on node versions thereof;
writing modified contents of the first file nodes to at least one of the second file nodes in ascending order of node versions of the second file nodes;
building node link information of each second file node that has been written;
marking the first file nodes with a predetermined flag; and
updating a node version of each second file node that has been written.

7. The method as recited in claim 6, wherein the node link information of each second file node is information on a logic sequence of the second file node from a preceding file node and to an offspring file node thereof.

8. The method as recited in claim 6, further comprising the following steps after the step of marking the first file nodes with a predetermined flag:
vacating the first file nodes that have been marked with the predetermined flag; and
canceling the link information of the vacated file nodes.

9. The method as recited in claim 8, further comprising the steps of:
updating node versions of the first file nodes that have been vacated; and
marking each of the first file nodes that have been vacated with an available flag.

10. The method as recited in claim 6, further comprising the step of:
marking each second file node that has been written with an unavailable flag.

11. A method for modifying file contents of a flash file stored in a flash memory which balances wear of the flash memory, the method comprising the steps of:
(a) finding first file nodes recording the file contents to be modified;
(b) searching for void file nodes in the flash memory, and selecting void file nodes as second file nodes;
(c) writing modified contents of the first file nodes to at least one of the second file nodes;
(d) building node link information of each second file node that has been written;
(e) vacating the first file nodes; and
(f) updating a node version of the written second file node and the vacated first file node.

12. The method as recited in claim 11, after said step (b), further including step (b1) sequencing the second file nodes based on node versions thereof, and said step (c) implemented in ascending order of node versions of the second file nodes.
